(19) United States
(12) Patent Application Publication
(10) Pub. No.: US 2026/0227045 A1
(43) Pub. Date: Aug. 6, 2026

(54) MICROLENS ARRAY COMPRISING A STRUCTURED OPTICAL ELEMENT

(71) Applicant: FOCUSLIGHT SWITZERLAND SA, Hauterive (CH)

(72) Inventors: Giorgio QUARANTA, Biel/Bienne (CH); Harald PIER, Cressier (CH)

(21) Appl. No.: 19/577,535

(22) Filed: Mar. 25, 2026

Related U.S. Application Data
(63) Continuation of application No. PCT/EP2024/075630, filed on Sep. 13, 2024.

(30) Foreign Application Priority Data
Sep. 25, 2023 (FR) FR2310139

(51) Int. Cl. F21S 41/20; F21S 41/40; F21V 5/00; F21S 41/143

(52) U.S. Cl. CPC F21S 41/285; F21S 41/40; F21V 5/004; F21V 5/008; F21S 41/143

(57) ABSTRACT

The invention relates to a microlens array for a vehicle light, comprising a plurality of incident microlenses through which light can enter the microlens array; a plurality of exit microlenses through which light can exit the microlens array; and a mask with a plurality of mask portions, which is located between the incident microlenses and the exit microlenses. A plurality of channels is established in the microlens array, through which light can pass. Each channel extends from at least one of the plurality of incident microlenses via at least one of the plurality of mask portions to at least one of the plurality of exit microlenses. A structured optical element is provided between the plurality of incident microlenses and the plurality of exit microlenses, which only partially obstructs light from travelling through the microlens array. The invention also relates to a vehicle light.

### TECHNICAL FIELD

The present invention relates to a microlens array and a vehicle light comprising a microlens array.

### BACKGROUND

Microlens arrays with a relatively short focal length are commonly applied in the automotive industry to reduce the size of vehicle lamps, in particular headlights.

For such applications, the beam pattern produced by the microlens array has to fulfill certain standards (that may differ in different countries). Many of these standards define a beam pattern with a cutoff line above which the light intensity shall not exceed a certain value in order to avoid dazzling other drivers driving in front or approaching from ahead.

When using a microlens array, the beam pattern is typically formed by a superposition of a plurality of individual beam patterns that are created by light travelling through individual channels of the microlens array.

An imaging layer (typically a mask located between the lenses) is applied for tailoring the individual beam patterns in the individual channels by blocking part of the light.

A known technical problem connected with this technology is the occurrence of projected patterns with undesirable optical effects that may be caused by crosstalk between the individual channels (in particular when a microlens array is illuminated with incident light that is partially collimated or not fully parallel to the orientation of the channels). Additionally, reflections occurring at interfaces between distinct materials comprising other elements of the headlight aggravate this issue.

### SUMMARY

These interferences may lead to undesired effects in the beam pattern of the headlight. In particular, the light intensity above the cutoff line may be unintentionally increased, which might cause dazzling of other road users and thus affects the overall road safety.

Hence, there is a need for improved microlens arrays and vehicle headlights which avoid the aforementioned problems.

The object of the invention is solved by a microlens array for a vehicle headlight. The microlens array comprises a plurality of incident microlenses through which light can enter the microlens array and a plurality of exit microlenses through which light can exit the microlens array. The microlens array also comprises a mask with a plurality of mask portions, wherein the mask is located between the incident microlenses and the exit microlenses. A plurality of channels is established in the microlens array, through which light can pass. Each channel extends from at least one of the plurality of incident microlenses via at least one of the plurality of mask portions to at least one of the plurality of exit microlenses. Particularly, each channel comprises exactly one incident microlens, exactly one mask portion and exactly one exit microlens. A structured optical element is provided between the plurality of incident microlenses and the plurality of exit microlenses. The structured optical element is configured to only partially obstruct light from travelling through the microlens array.

It was found out that by obstructing a part of the light from travelling through the microlens array, undesirable optical effects in the projected pattern, in particular those caused by sharp transitions, for instance due to a step in the mask, can be significantly reduced. At the same time, the part of the light that is not obstructed from passing through the microlens array can contribute to the beam pattern, in particular the brightness of the projection. These advantages are in particular persisted when the microlens array is not illuminated head-on but at an angle.

A structured optical element in the sense of the invention can be an at least two-dimensional structure that is configured to selectively block light in a first area and transmit light in a second area, wherein the border between both areas has a distinct two-dimensional shape, for example a finger structure, a zick-zack structure, a structure with transmission holes, a structure with blocking spots or an irregular edge between the first and second area with a random structure.

Generally, the structured optical element is provided in addition to a regular structure of the mask portion that is used to shape the beam pattern in order to fulfill the standards (that may differ in different countries). As indicated, these standards define a beam pattern with the cutoff line above which the light intensity shall not exceed a certain value in order to avoid dazzling other drivers driving in front or approaching from ahead. Specifically, the structured optical element may located at an opposite side with respect to the regular structure used for shaping the beam pattern in order to fulfill the standards.

The structured optical element can be configured to blur an intensity of the light travelling through the microlens array by means of its structure. The blurring is most effective to reduce the occurrence of unwanted optical effects in the beam pattern. The intensity may be blurred by means of different structures. The respective structure chosen for blurring the intensity inter alia depends on the specific application (left-hand traffic and right-hand traffic) as well as a tradeoff between manufacturing costs and effectiveness. For instance, a certain structure may have a high effectiveness, but it is very expensive in manufacturing such that a different structure being less expensive in manufacturing is selected even though its effectiveness is lower provided that costs are more important than effectiveness.

In a preferred embodiment, each of the plurality of mask portions comprises an edge with two essentially linear sections extending in parallel and offset from each other. The edge further comprises a linking section that connects the linear sections.

The purpose of the linear sections and the linking section, which can be for example a step that connects the linear sections, is to define the shape of the light beam exiting the microlens array, in particular to control the beam patterns upper horizontal edge. This is important to avoid too high light intensities above the cutoff line, which might cause dazzling of other road users.

In this context, terms such as “horizontal”, “vertical”, “up”, “upper”, “down” “lower” etc. are used to indicate different directions and/or orientations in the intended main application, in particular with respect to the installation situation of the microlens array in the headlight of a vehicle. This terminology is used herein only for the purpose of improving the comprehensibility and is not intended to be limiting to the invention.

In one variant of the microlens array, adjacent linear sections of two neighboring mask portions are offset from each other in a direction perpendicular to the extension direction of the linear sections and connected to each other by the at least one structured optical element.

The offset between adjacent linear sections of two neighboring mask portions is a consequence of the aforementioned linking section that is used to define the individual beam shapes of individual channels. By establishing a connection of the two adjacent linear sections by means of the at least one structured optical element, particularly instead of a step and/or a sharp (straight) edge, the formation of interference patterns and/or unwanted optical effects in the beam pattern can be effectively suppressed or at least reduced.

It is conceivable that adjacent linear sections of two neighboring mask portions are connected with each other by means of an edge of the structured optical element, wherein the edge differs from a straight line. It has been found out that shaping the connecting edge between the adjacent linear sections, thereby creating the structured optical element, is a simple and yet effective way to reduce unwanted optical effects in the projected image.

For example, the edge of the structured optical element may be shaped such that it comprises several steps. The steps can be in the in the size range of a few micrometers each to effectively influence the light passing by and the number of steps may depend on the offset distance between the adjacent linear line sections.

Typically, the linking section connecting the linear sections of the edge is a straight line that is tilted with respect to the extension direction of the linear sections. For instance, the linking section extends from left down to right up or rather right down to left up, which actually depends on the application scenario, namely left-hand traffic or right-hand traffic.

In contrast to the linking section, the structured optical element may generally have an opposite orientation. Alternatively, the orientation of the structured optical element is perpendicular with respect to the extension direction of the linear sections.

In any case, the edge of the structured optical element differs from a (tilted) straight line, as a straight line generally does not blur the intensity of the light travelling through the microlens array. Consequently, the effect according to the invention could not be achieved by means of a straight line irrespective thereof it is a tilted straight line or a single step between the adjacent linear sections of two neighboring mask portions.

In one embodiment, the at least one structured optical element is asymmetrical with respect to an axis, particular any axis, running through a point being located in the middle of a virtual line interconnecting opposing ends of adjacent linear sections of two neighboring mask portions. In particular, the axis can be perpendicular to the virtual line. It has been found out that avoiding symmetry supports suppression of unwanted optical effects in the beam pattern.

In another variant, the at least one structured optical element comprises a finger structure. In particular, the edge of the structured optical element can form the finger structure. The finger structure offers alternating light blocking (opaque) regions and light transmitting (transparent) regions that are well suited for partially obstructing light from travelling through the microlens array.

The finger structure may comprise a plurality of fingers with different lengths and/or widths. The fingers are spaced apart from each other and may or may not extend in the same direction. It is conceivable, that the dimension and spacing of the fingers are selected to exactly match the requirements of the desired application. In particular, by defining the dimension and position of an individual finger, a certain part of the beam pattern can be selectively influenced. The fingers may be straight, curved, parallel with respect to each other or tilted with respect to each other.

In another embodiment, the at least one structured optical element comprises at least one transmission hole within the mask, in particular wherein the at least one transmission hole is located in proximity to an edge of the at least one structured optical element. For example, the at least one transmission hole can be located in proximity to the connection of the linear sections of two neighboring mask portions. Particularly, several transmission holes are provided within the mask, wherein they are located in proximity to the edge of the at least one structured optical element.

Additionally or alternatively, the at least one structured optical element may comprise at least one blocking spot that is located in one of the plurality of mask portions. In particular, the blocking spot can be located in a transmissive or transparent part of the mask portion and/or in proximity to the connection of the linear sections of two neighboring mask portions.

The transmission holes and blocking spots both are technically simple to implement and well suitable for partially obstructing light from travelling through the microlens array and/or to blur the intensity of the light travelling through the microlens array, particularly in a defined manner. This actually depends on the number, size and/or location of the transmission holes and/or blocking spots.

In one variant, the at least one structured optical element is fully located within one of the plurality of channels. The structured optical element therefore partially obstructs light from travelling through the corresponding channel(s), thereby avoiding or reducing unwanted optical effects that may otherwise be caused by the light.

It is also conceivable that at least one transition region is provided between two neighbored channels. In other words, the neighbored channels are spaced from each other by means of the at least one transition region. Alternatively, neighbored channels are directly neighbored, e.g. the neighbored channels have point contact.

In one embodiment, the structured optical element is completely located in the transition region. It therefore partially obstructs light from travelling through the transition region, for example due to crosstalk, thus avoiding or reducing unwanted optical effects that may otherwise be caused by the light.

Alternatively, the structured optical element may also be located in both, the transition region and a channel neighbored to the transition region. The structured optical element can therefore effectively influence light travelling through the channel as well as the transition region, thus avoiding or reducing unwanted optical effects that may otherwise be caused by the light.

In a specific embodiment, the structured optical element may be located in a first channel, an adjacent transition region and a second channel adjoining the adjacent transition region on the opposite side.

Actually, the structured optical element may be located in two neighbored channels and an optional transition region located between the neighbored channels.

In another preferred embodiment, two or more structured optical elements are provided, wherein the structured optical elements differ from each other with regard to their structure. Due to the application of these differently structured optical elements, in particular in different regions of the microlens array, the individual light beams travelling through these regions are shaped differently. Due to their different shape, a superposition of these individual beams results in a blurred intensity distribution and not in unwanted strongly pronounced unwanted optical effects in the (superimposed) beam pattern. For example, the two or more structured optical elements are located in different channels and/or in different transition regions.

In one variant of the microlens array, the at least one structured optical element has a feature size of less than 50 µm. In this context, feature size is understood as the dimension of the structures of the structured optical element that influence the transmission or blocking of light, for example the length or width of the fingers in a finger structure and/or the diameter of transmission holes or blocking spots, also called opaque dots. It was found out that structures below 50 µm, in particular between 3 µm and 30 µm, can be manufactured easily and effectively blur the intensity of the light passing them.

Alternatively, the at least one structured optical element can have a feature size within the wavelength region of visible and/or infrared light, in particular between 300 nm and 3 µm.

When applying structured optical elements with such small feature size, the light travelling past them is at least partially diffracted. As a consequence, the intensity distribution is blurred and the occurrence of distinct unwanted optical effects in the beam pattern is suppressed or at least reduced.

In another embodiment, at least two of the plurality of mask portions differ from each other such that they project different individual beam patterns when light is travelling through them. By applying different mask portions, a diversity of different individual beam patterns can be created (for example in the individual channels) which supports suppression of undesirable optical effects in the superimposed beam pattern.

In a further variant, at least three of the plurality of mask portions differ from each other such that they project individual beam patterns that incrementally differ from each other when light is travelling through them. In particular, the three different mask portions can be located in different neighboring channels.

For example, the differing mask portions can be arranged in the microlens array from left to right.

This particular design allows to change between the projected beam patterns on purpose by changing the illuminated areas of the microlens array. For example, multiple LEDs can be applied and selectively operated to illuminate different parts of the microlens array, thereby creating the different beam patterns.

For example, the incident microlenses and/or the exit microlenses are cylindrical lenses.

The object of the invention is also solved by a vehicle light, in particular a headlight, comprising at least one light source, a collimation optics and a microlens array as described above. The advantages that were discussed for the microlens array also apply for the vehicle light in a similar manner.

### BRIEF DESCRIPTION OF FIGURES

Further advantages and features will become apparent from the following description of the invention and from the appended figures, which show a non-limiting exemplary embodiment of the invention and in which:

FIG. 1 schematically shows a side view of a vehicle headlight according to the invention;

FIG. 2 schematically shows a front view of a section of a first embodiment of a microlens array according to the invention;

FIG. 3 schematically shows a desired beam pattern that shall be formed when a vehicle headlight irradiates light to a screen located at a predetermined distance;

FIG. 4 schematically shows a beam pattern with unwanted optical effects;

FIG. 5 schematically shows a front view of a section of a second embodiment of a microlens array according to the invention;

FIG. 6 schematically shows a front view of a section of a third embodiment of a microlens array according to the invention;

FIG. 7 schematically shows a front view of a section of a fourth embodiment of a microlens array according to the invention;

FIG. 8 schematically shows an example of a structured optical element for a microlens array according to the invention;

FIG. 9 schematically shows another example of a structured optical element for a microlens array according to the invention;

FIG. 10 schematically shows a further example of a structured optical element for a microlens array according to the invention;

FIG. 11 schematically shows another example of a structured optical element for a microlens array according to the invention;

FIG. 12 schematically shows a further example of a structured optical element for a microlens array according to the invention;

FIG. 13 schematically shows another example of a structured optical element for a microlens array according to the invention;

FIG. 14 schematically shows a further example of a structured optical element for a microlens array according to the invention;

FIG. 15 schematically shows another example of a structured optical element for a microlens array according to the invention; and

FIG. 16 schematically shows an example of multiple different mask portions arranged in a row.

### DETAILED DESCRIPTION

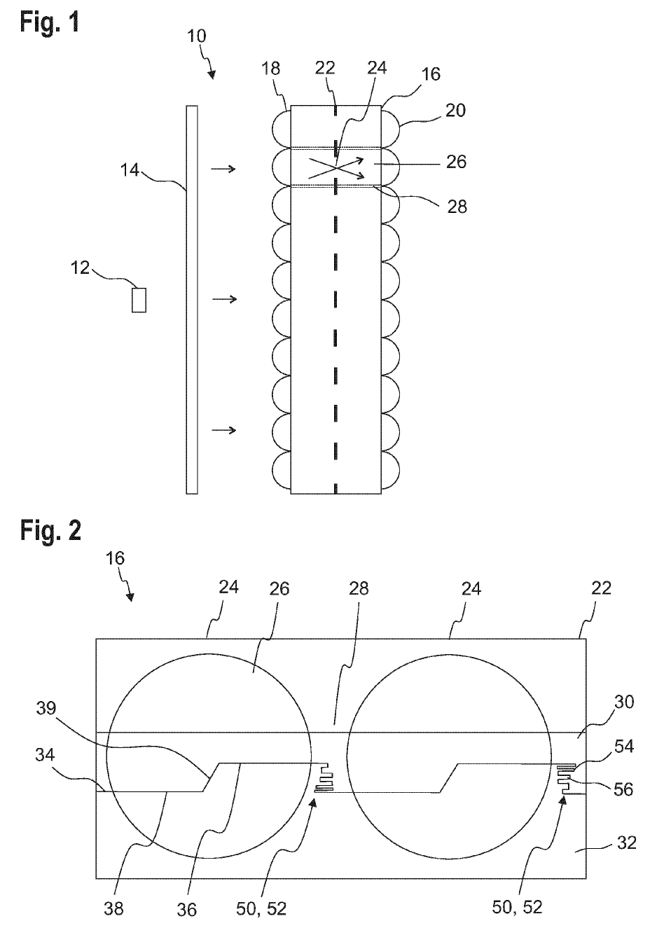

FIG. 1 schematically shows a side view of an embodiment of a vehicle light 10 according to the invention. The vehicle light 10 is a headlight and comprises at least one light source 12, for example an LED or array of LEDs. Hence, one light source or several light sources might be provided. Further, the vehicle light 10 comprises a collimation optics 14, for example a Fresnel lens to collimate the light emitted from the at least one light source 12.

The vehicle light 10 also comprises a microlens array 16. The microlens array 16 comprises a plurality of incident microlenses 18 through which light can enter the microlens array 16 and a plurality of exit microlenses 20 through which light can exit the microlens array 16.

For example, the incident microlenses 18 and/or the exit microlenses 20 are cylindrical lenses.

In addition, the microlens array 16 has a mask 22 with a plurality of mask portions 24, which is located between the incident microlenses 18 and the exit microlenses 20.

In the shown embodiment, the mask 22 is located in a focal plane of the incident microlenses 18 as well as in a focal plane of the exit microlenses 20. This is of course not limiting to the invention. In other embodiments, the mask 22 might be located closer to or further away from the incident microlenses 18 and/or exit microlenses 20 than their respective focal plane(s). Generally, this depends on the application scenario and/or the dimensions of the microlens array 16.

In the microlens array 16, a plurality of channels 26 is established, through which light can pass.

In the embodiment, each of the channels 26 extends from one of the incident microlenses 18 via one of the mask portions 24 to one of the exit microlenses 20. In other words, each incident microlens 18 is associated with one corresponding exit microlens 20, wherein a part of the mask is located between them, which is defined as the mask portion 24.

Each of the mask portions 24 shown in FIG. 1 thereby defines an image that is projected by the light travelling through the channel 26 comprising the respective mask portion 24.

In the shown embodiment, transition regions 28 are located between neighboring channels 26. It is conceivable that no or only very little light travels through these transition regions 28 when the microlens array 16 is illuminated head-on (in the direction of the channels 26). However, a significant amount of light may travel through the transition regions 28 when the microlens array 16 is illuminated at an angle or is illuminated with a partially-collimated light, due to crosstalk and/or due to reflections. This may cause unwanted optical effects in the light beam as will be discussed later in more detail.

FIG. 2 schematically shows a front view of a section of the microlens array 16 of FIG. 1, e.g. two neighboring channels 26 and one transition region 28 between the neighboring channels 26.

In the embodiment, the mask 22 has an elongated transmissive area 30, e.g. an opening, that extends across multiple mask portions 24, particularly in a horizontal direction. As indicated above, the mask portions 24 are those regions of the mask 22 that are associated with the channels 26.

In vertical direction, the transmissive area 30 is limited by opaque areas 32 of the mask 22, which are located in opposite sides of the transmissive area 30 in vertical direction.

The mask 22 comprises a lower edge 34 which is a border between the transmissive area 30 and one of the opaque areas 32 of the mask 22.

In the respective mask portions 24, the lower edge 34 has a first (essentially) linear section 36 and a second (essentially) linear section 38. Both linear sections 36, 38 extend in parallel, namely in the horizontal direction. The linear sections 36, 38 are vertically offset from each other.

In the respective mask portions 24, the lower edge 34 furthermore comprises a linking section 39 that connects the first linear section 36 and the second linear section 38. As shown, the linking section 39 is a tilted straight line.

The purpose of this particular design of the mask portions 24 is to create a beam pattern that is suitable for vehicle lights 10, in particular headlights, by selectively obstructing light from passing through the microlens array 16. In fact, the linking section 39 ensures that the beam pattern fulfills standards with regard to official regulations and/or standards defined by Original Equipment Manufacturers (OEMs) or Tier 1 suppliers.

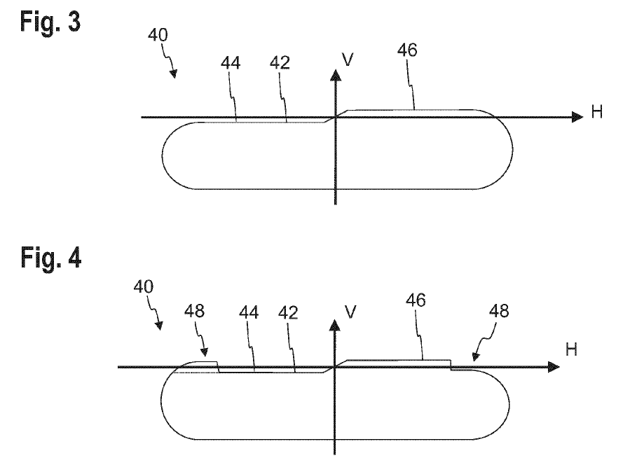

FIG. 3 schematically shows a desired beam pattern 40 of a vehicle light 10, for example a headlight for right-hand traffic. The desired beam pattern 40 may be defined by a country specific regulations and/or standards as discussed before.

On the upper end, the beam pattern 40 has a cutoff line 42 above which the light intensity shall not exceed a certain value in order to avoid dazzling of other drivers driving in front or approaching from ahead.

As can be seen from FIG. 3, the cutoff line 42 has a lower portion 44 on the left side and a higher portion 46 on the right side. This ensures a light distribution with a maximized intensity where it is needed most, in particular on the own driving lane and on the right to it, such that for example traffic signs on the right can be illuminated appropriately. At the same time, dazzling drivers of cars driving in front or pedestrians is avoided.

It is conceivable that the lower edge 34 of the mask 22 defines or at least highly influence the shape of the cutoff line 42. In particular, the lower portion 44 of the cutoff line 42 may be defined by the fist linear sections 36 and the higher portion 46 may be defined by the second linear sections 38.

It is known from prior art that in conventional vehicle headlights comprising conventional microlens arrays, optical interferences can occur that may result in an irregular beam pattern 40.

FIG. 4 shows such an irregular beam pattern 40 that can for example occur when a microlens array 16 is applied with a mask 22 that has a distinct sharp step or corner connecting the first and second linear sections 36, 38 of neighboring channels 26.

As shown in FIG. 4, the irregular beam pattern 40 comprises unwanted optical effects 48. Due to these optical effects 48, the light intensity above the cutoff line 42 can be increased in some areas, which might cause dazzling of other drivers driving in front or approaching from ahead.

In order to avoid or at least weaken the occurrence of such unwanted optical effects 48, the microlens array 16 shown in FIG. 2 comprises structured optical elements 50 that are provided between the plurality of incident microlenses 18 and the plurality of exit microlenses 20. In the embodiment, the structured optical elements 50 are a part of the mask 22.

As shown in FIG. 2, the structured optical elements 50 are located in the transition regions 28, in particular in an area between the neighboring channels 26.

The structured optical elements 50 connect adjacent linear sections 36, 38 of neighboring mask portions 24, which are offset from each other in a direction perpendicular to the extension direction of the linear sections 36, 38, namely offset in vertical direction.

In the shown embodiment, the structured optical elements 50 are established by finger structures 52. In this case, edges 54 of the structured optical elements 50 are part of the lower edge 34 of the mask 22.

In fact, the edges 54 of the structured optical elements 50 connect adjacent linear sections 36, 38 of the neighboring mask portions 24 with each other.

In the shown embodiment, the upper linear section 36 of the left mask portion 24 as well as the lower linear section 38 of the right mask portion 24 are connected to the edge 54 of the corresponding structured optical element 50 located between the mask portions 24. This however depends on the application scenario. In fact, the edge 54 of the structured optical element 50 may also be connected to the lower linear section 38 of the left mask portion 24 as well as the upper linear section 36 of the right mask portion 24. As indicated above, this depends whether the application concerns left-hand traffic or right-hand traffic.

Due to establishing these connections by means of the finger structures 52 instead of straight lines, big steps in the lower edge 34 of the mask 22 are avoided, which could cause unwanted optical effects 48 in the beam pattern 40.

As shown in FIG. 2, the finger structures 52 comprise a plurality of fingers 56 with different lengths and widths.

In the embodiment, the fingers 56 have a feature size (their length and width) that ranges between 3 µm and 30 µm.

As shown in FIG. 2, all fingers 56 extend in the same direction, e.g. the horizontal direction, and are spaced apart from each other. For instance, the fingers 56 are parallel with respect to each other.

Importantly, the structured optical elements 50 only partially obstruct light that is illuminated on them from travelling through the microlens array 16. The part of the light that is not obstructed from passing through the microlens array 16 can contribute to the beam pattern 40 of the vehicle light 10.

By means of their structure, the structured optical elements 50 blur an intensity of the light travelling through the microlens array 16, thereby reducing interference effects and thus unwanted optical effects 48 in the beam pattern 40.

In the shown embodiment, the respective structure of the structured optical elements 50 is defined by the shape and/or orientation of the finger structure 52 which cause the blurring of the intensity of the light travelling through the microlens array 16.

In the embodiment of FIG. 2, multiple structured optical elements 50 are shown, which differ from each other with regard to their structure.

The multiple different structured optical elements 50 can for example be located in different regions, in particular in different channels 26 or different transition regions 28, as shown in FIG. 2. Hence, individual light beams travelling through these different regions are shaped differently by the different structured optical elements 50. A superposition of these individual beams results in a blurred intensity distribution and is thus useful to avoid unwanted optical effects 48 in the superimposed beam pattern 40.

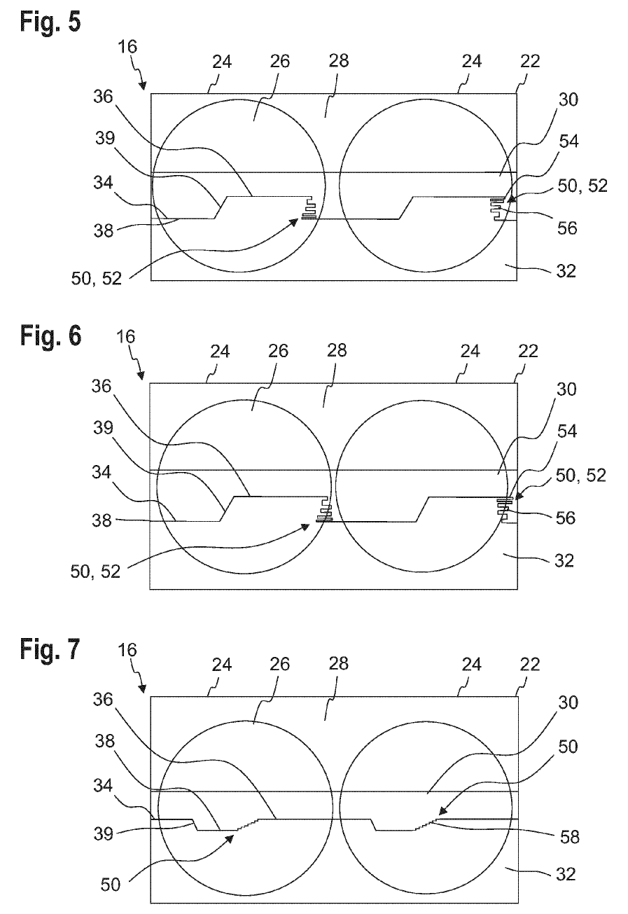

FIGS. 5 schematically shows a front view of a section of a second embodiment of a microlens array 16 according to the invention. The second embodiment corresponds in several important aspects to the first embodiment. Hence, only differences are described. The same reference numbers are used for identical or functionally identical elements.

In FIG. 5, the structured optical elements 50 are located fully within the channels 26. The structured optical elements 50 are configured to partially obstruct part of the light from travelling through the channels 26 in which they are located, thus avoiding or reducing unwanted optical effects 48 that may otherwise be caused by this part of the light.

A transition region 28 is still provided between the neighboring channels 26. However, this transition region 28 is optional. Hence, the neighboring channels 26 may also directly contact each other, for instance by means of a point contact.

FIG. 6 schematically shows a front view of a section of a third embodiment of a microlens array 16 according to the invention. The third embodiment corresponds in several important aspects to the first and second embodiment. Hence, only differences are described. The same reference numbers are used for identical or functionally identical elements.

In FIG. 6, the structured optical elements 50 are located in both, the transition regions 28 and the channels 26 neighbored to the respective transition regions 28. Due to their position, the structured optical elements 50 are configured to partially obstruct part of the light from travelling through the respective channels 26 as well as transition regions 28 in which they are located, thus avoiding or reducing unwanted optical effects 48 that may otherwise be caused by this part of the light.

It is also conceivable that at least one structured optical element 50 extends along two neighboring channels 26 and the transition region 28 located between the neighboring channels 26.

FIGS. 7 schematically shows a front view of a section of a fourth embodiment of a microlens array 16 according to the invention. The fourth embodiment corresponds in several important aspects to the first, second and third embodiment. Hence, only differences are described. The same reference numbers are used for identical or functionally identical elements.

Similar to FIG. 5, the structured optical elements 50 of FIG. 7 are located fully within the channels 26.

In the fourth embodiment, the structured optical elements 50 each comprise multiple steps 58 that form part of the lower edges 34 of the corresponding mask portions 24. The steps 58 have a feature size, e.g. their height and length, of a few micrometers, which is sufficient to effectively influence the individual light beams travelling through the respective channels 26 in which the structured optical elements 50 are located.

As shown in FIG. 7, the structured optical elements 50 generally have an orientation that is opposite to the orientation of the linking section 39.

Moreover, the structured optical elements 50 is different from a straight line which would not blur the intensity of the light. Actually, the blurring is obtained by the several steps 58.

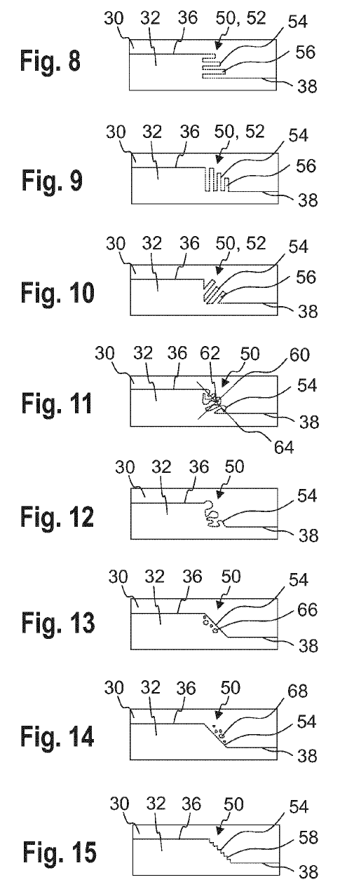

FIGS. 8 to 15 schematically show further examples of shapes of structured optical elements 50 that can be applied in microlens arrays 16 according to the invention, in particular to connect first linear portions 36 and second linear portions 38 of different mask portions 24.

FIG. 8 schematically shows an example of a structured optical element 50 with a finger structure 52 comprising horizontally aligned fingers 56 that consecutively vary in length.

FIG. 9 schematically shows an example of a structured optical element 50 with a finger structure 52 comprising vertically aligned fingers 56 that consecutively vary in length.

FIG. 10 schematically shows an example of a structured optical element 50 with a finger structure 52 comprising fingers 56 aligned at an angle of approximately 45° with respect to the linear sections 36, 38. Other angles may also be chosen

FIG. 11 schematically shows an example of a structured optical element 50 with an irregular structure. The depicted structured optical element 50 is asymmetrical with respect to an axis 60 running through a point 62 being located in the middle of a virtual line 64 interconnecting opposing ends of adjacent linear sections 36, 38 of two neighboring mask portions 24. In FIG. 11, the axis 60 is perpendicular to the virtual line 64.

FIG. 12 schematically shows another example of a structured optical element 50 similar to the structured optical element 50 of FIG. 11, but with a coarser irregular structure.

FIG. 13 schematically shows another example of a structured optical element 50, comprising multiple transmission holes 66. The transmission holes 66 can be located within an opaque area 32 of the mask 22. In FIG. 13, the transmission holes 66 are all located in proximity to the edge 54 of the structured optical element 50.

FIG. 14 schematically shows a further example of a structured optical element 50 comprising multiple blocking spots 68. The blocking spots 68 can be located within the transmissive area 30 of the mask 22, particularly within one mask portion 24 or a transition region 28, e.g. between two mask portions 24. In FIG. 13, the blocking spots 68 are all located in proximity to the edge 54 of the structured optical element 50.

FIG. 15 schematically shows another example of a structured optical element 50 comprising an edge 54 with steps 58, similar to the structured optical elements 50 of FIG. 7.

Of course, the scope of the invention is not limited to the specific types of structured optical elements 50 shown in FIGS. 8-15. Other types of structured optical elements 50, in particular such that are combinations of two or more of the different described structured optical elements 50, can be applied.

All of these specific types of structured optical elements 50 however have in common that an intensity of the light travelling through the microlens array 16 is blurred by means of the respective structure of the structured optical elements 50.

As already indicated above, the structured optical elements 50 are established in addition to the linking section 39 used to shape the beam pattern according to regulations/standards. Contrary to the structured optical elements 50, the linking section 39 has to be located within the corresponding channel 26. Further, contrary to the linking section 39 provided by a straight line, an edge of the structured optical element 50 has a different shape, e.g. staircase-shaped with several steps.

In a further embodiment, the feature size of at least one of the applied structured optical elements 50 is within the wavelength region of visible and/or IR-light, preferably between 300 nm and 3 µm, to make use of diffraction effects for blurring the intensity of the light travelling through the microlens array 16, thus avoiding or at least reducing unwanted optical effects 48 in the beam pattern 40.

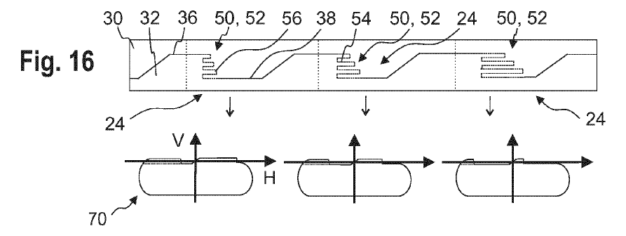

FIG. 16 schematically shows multiple different mask portions 24 arranged in a row. For example, the different mask portions 24 can be arranged in a microlens array 16 from the left to the right. In the embodiment, the different mask portions 24 are located in different neighboring channels 26.

As shown in FIG. 16, the mask portions 24 differ from each other in the size of the transmissive areas 30 and opaque areas 32. For example, by applying structured optical elements 50 with a finger structure 52 having longer or wider fingers 56 (as shown on the right), the size of the transmissive area 30 can be reduced and the size of opaque area 32 increased.

Of course, other structures of the structured optical elements 50 than the finger structure 52 may also be used, e.g. combinations of different structures.

The different mask portions 24 shown in FIG. 16 project different individual beam patterns 70 when light is travelling through them.

In the example, the individual beam patterns 70 projected by the different mask portions 24 shown in FIG. 16 incrementally differ from each other. In other words, there is a stepwise change of the individual beam patterns 70 (in the example from the left to the right).

It is conceivable that in a vehicle lamp 10, the light source 12 can be configured to illuminate selective parts of the microlens array 16, e.g. it may comprise multiple LEDs that can be selectively switched on or off.

In particular, the light source 12 can be configured to irradiate different channels 26 comprising the different mask portions 24. In this way it is possible to select the individual beam patterns 70 to be projected and thus also the shape of the superimposed beam pattern 40.

1. A microlens array, comprising:
a plurality of incident microlenses through which light can enter the microlens array;
a plurality of exit microlenses through which light can exit the microlens array; and
a mask with a plurality of mask portions, which is located between the incident microlenses and the exit microlenses;
wherein a plurality of channels is established in the microlens array, through which light can pass, each channel extending from at least one of the plurality of incident microlenses via at least one of the plurality of mask portions to at least one of the plurality of exit microlenses; and
wherein a structured optical element is provided between the plurality of incident microlenses and the plurality of exit microlenses, which only partially obstructs light from travelling through the microlens array.

2. The microlens array of claim 1, wherein the structured optical element is configured to blur an intensity of the light travelling through the microlens array by means of its structure.

3. The microlens array of claim 1, wherein each of the plurality of mask portions comprises an edge with two essentially linear sections extending in parallel and offset from each other, wherein the edge comprises a linking section that connects the linear sections.

4. The microlens array of claim 3, wherein adjacent linear sections of two neighboring mask portions are offset from each other in a direction perpendicular to the extension direction of the linear sections, and wherein the adjacent linear sections are connected by the at least one structured optical element.

5. The microlens array of claim 3, wherein adjacent linear sections of two neighboring mask portions are connected with each other by means of an edge of the structured optical element, and wherein the edge differs from a straight line.

6. The microlens array of claim 5, wherein the edge of the structured optical element comprises several steps.

7. The microlens array of claim 3, wherein the at least one structured optical element is asymmetrical with respect to an axis running through a point being located in the middle of a virtual line interconnecting opposing ends of adjacent linear sections of two neighboring mask portions, and wherein the axis is perpendicular to the virtual line.

8. The microlens array of claim 1, wherein the at least one structured optical element comprises a finger structure.

9. The microlens array of claim 8, wherein the finger structure comprises a plurality of fingers with different lengths and/or widths, in particular wherein the fingers extend in the same direction and are spaced apart from each other.

10. The microlens array of claim 1, wherein the at least one structured optical element comprises at least one transmission hole within the mask, in particular wherein the at least one transmission hole is located in proximity to an edge of the at least one structured optical element.

11. The microlens array of claim 1, wherein the at least one structured optical element comprises at least one blocking spot that is located in one of the plurality of mask portions.

12. The microlens array of claim 1, wherein the at least one structured optical element is fully located within one of the plurality of channels.

13. The microlens array of claim 1, wherein at least one transition region is provided between two neighbored channels.

14. The microlens array of claim 13, wherein the structured optical element is completely located in the transition region.

15. The microlens array of claim 13, wherein the structured optical element is located in both the transition region and a channel neighbored to the transition region.

16. The microlens array of claim 1, wherein two or more structured optical elements are provided, and wherein the structured optical elements differ from each other with regard to their structure.

17. The microlens array of claim 1, wherein the at least one structured optical element has a feature size of less than 50 µm.

18. The microlens array of claim 1, wherein the at least one structured optical element has a feature size within the wavelength region of visible light.

19. The microlens array of claim 1, wherein at least two of the plurality of mask portions differ from each other such that they project different individual beam patterns when light is travelling through them.

20. The microlens array of claim 1, wherein at least three of the plurality of mask portions differ from each other such that they project individual beam patterns that incrementally differ from each other when light is travelling through them.

21. A vehicle light comprising:
at least one light source;
a collimation optics; and
a microlens array according claim 1.
